(19) United States
(12) Patent Application Publication
(10) Pub. No.: US 2023/0235620 A1
(43) Pub. Date: Jul. 27, 2023

(54) DE-MAG DOOR PLATE

(71) Applicant: Eric Elterman, Brooklyn, NY (US)

(72) Inventor: Eric Elterman, Brooklyn, NY (US)

(21) Appl. No.: 18/159,294

(22) Filed: Jan. 25, 2023

Related U.S. Application Data
(60) Provisional application No. 63/267,133, filed on Jan. 25, 2022.

(51) Int. Cl. E06B 7/28

(52) U.S. Cl. CPC E06B 7/28

(57) ABSTRACT

A device is provided for removable attachment to a door to prevent the flexible magnetic screen door from becoming stuck on the door, thus allowing a magnetic screen to work as designed. A device of the present invention improves the functionality of magnetic screen doors that are installed near ferromagnetic elements by blocking the area where magnetic attraction is unwanted by removably attaching to the door via magnetic attraction on a rear face and exhibiting non-ferromagnetic properties on a front face. allowing for easy installation and removal. Ferromagnetic properties on a rear face may be provided by a plurality of magnets that adhere or are embedded in the device.

### PRIORITY CLAIM

This application claims priority to U.S. Patent Application No. 63/267,133, filed Jan. 25, 2022, and titled, “DE-MAG DOOR PLATE,” the contents of which is incorporated by reference in its entirety.

### BACKGROUND

Flexible magnetic screen doors have become a popular addition for outdoor-facing entryways such as patios. These doors typically feature a pair of rectangular fabric mesh panels that connect to a door frame with sticky adhesive and or tacks. A joining surface on each panel may be lined with magnets to cause the panels to be held in a closed configuration by magnetic attraction. The door thus opens and closes along a seem that is held together with magnets when closed. These doors provide flexibility and ease of use, particular for high-traffic areas. An exemplary flexible magnetic screen door is shown in FIG. 1.

Companies that make these flexible magnetic screen doors include Flux Phenom, Homearda, Magzo, Yotache, lkstar, and Megamesh.

An unwanted side effect of these doors is a magnetic attraction to an adjacent magnetic surface, which can cause the screen to close and compromise the functionality of the screen door. Should the door become stuck on exterior doors that attract magnets, an opening may be created for insects or debris, compromising the purpose of the screen. An example of this condition is shown in FIG. 2.

Existing door plates such as “kick plates” are designed to prevent damage to the door and do nothing to prevent unwanted connection between a flexible magnetic screen door and a magnetic surface. Flexible magnetic strips, stainless steel plates with magnetic strips glue to the rear surface, and aluminum- or nickel-plated panels have all been proposed, though none of these provide relief from the problem of magnetic attraction comprising the function of the screen.

Further, many of these solutions require complex and permanent installation and require drilling holes into the exterior door, permanently altering the door.

### BRIEF DESCRIPTION OF THE DRAWINGS

The features and advantages of the present disclosure will be more fully understood with reference to the following detailed description when taken in conjunction with the accompanying figures, wherein:

FIG. 1 depicts a flexible magnetic screen according to the prior art;

FIG. 2 depicts a flexible magnetic screen according to the prior art shown in a different configuration of use;

FIG. 3 depicts a perspective view of a device according to a preferred embodiment of the invention;

FIGS. 4-5 is a block diagram depict a device of the preferred embodiment comprising wood;

FIGS. 6a-6b depict a further view a device according to a preferred embodiment of the invention; and

FIG. 7 depicts a further embodiment of the present invention.

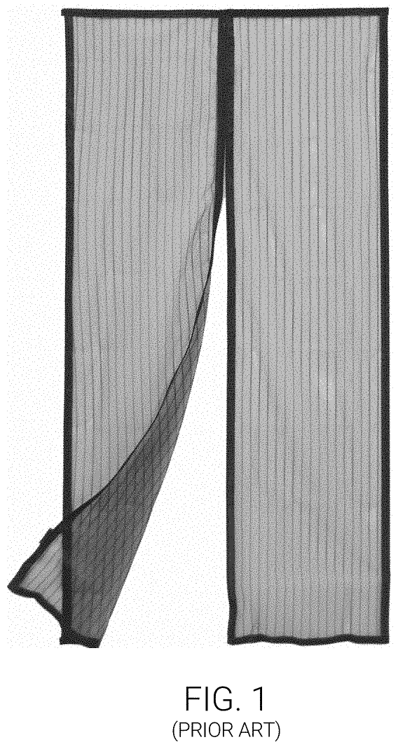

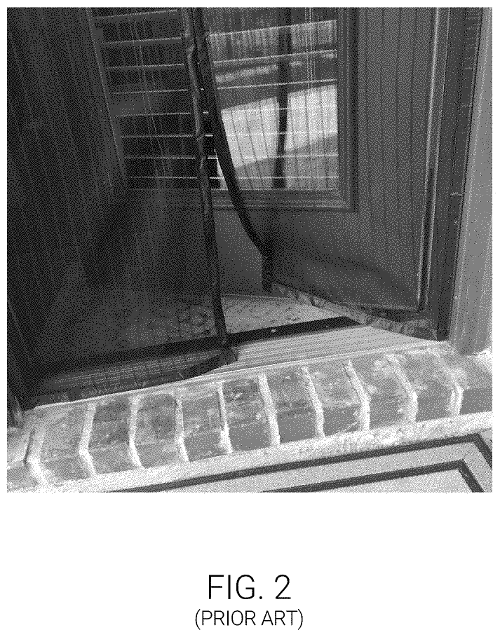

### SUMMARY

In an embodiment of the invention, a device is disclosed for improving the functionality of a magnetic screen door installed adjacent a ferromagnetic element, the device including a panel comprising a rear surface that exhibits ferromagnetic properties and a front surface that does not exhibit ferromagnetic properties. In embodiments of the invention, the panel may be configured to removably mate with the surface of a door surface via ferromagnetic attraction.

In further embodiments of the invention, the front surface may be made from any of wood, a polymer, rubber, or vinyl. In further embodiments of the invention, the rear surface may comprise a plurality of magnetic elements that have been joined rear surface using an adhesive or a plurality of magnetic elements that have been embedded into the rear surface.

In further embodiments of the invention, the front surface may be configured to cover only an area where the magnetic attraction is not desired. In further embodiments, the device may be shaped and styled to match the underlying door surface.

### DETAILED DESCRIPTION

In embodiments of the invention, a device is provided for removable attachment to a door to prevent the flexible magnetic screen door from becoming stuck on the door, thus allowing a magnetic screen to work as designed.

In embodiments, the device of the present invention improves the functionality of magnetic screen doors that are installed near ferromagnetic elements by blocking the area where magnetic attraction is unwanted.

In embodiments of the invention, a device may removably attach to the door via magnetic attraction, allowing for easy installation and removal.

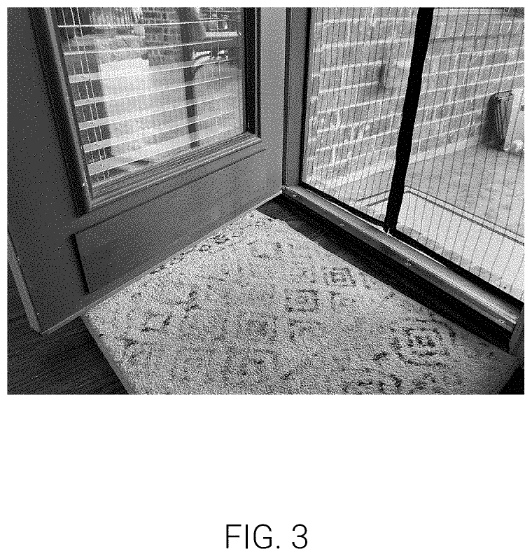

An exemplary embodiment of the present invention is shown in FIG. 3.

In embodiments of the invention, the device of the present invention comprises a non-magnetic material, such as wood, plastic, rubber, or vinyl.

In embodiments of the invention, magnets may be attached to the non-magnetic material via an adhesive and/or structural design. Magnets may be used to install or connect the device to the adjacent door or desired area.

In embodiments of the invention, magnets may be embedded into the back of the strip, allowing the strip to be easily attached flush against a door and to be easily removed if needed.

In embodiments of the invention, the non-magnetic material may be shaped to cover only an area where the magnetic attraction is not desired. In embodiments of the invention, the device may be decorative and match the color or texture of the underlying door segment.

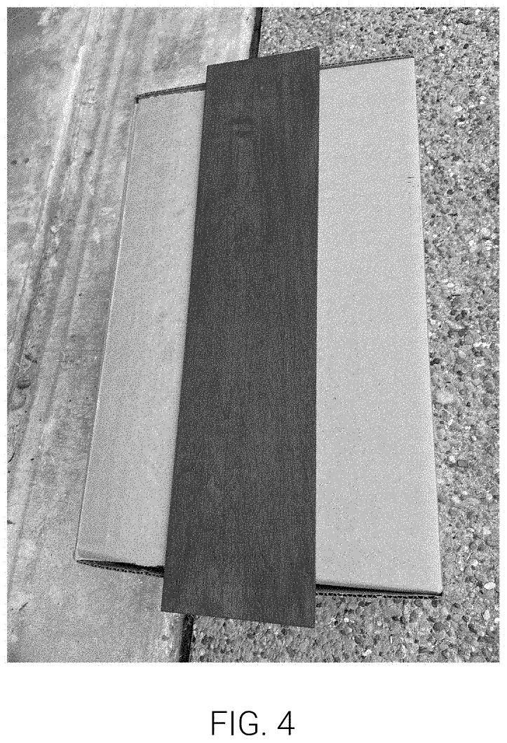

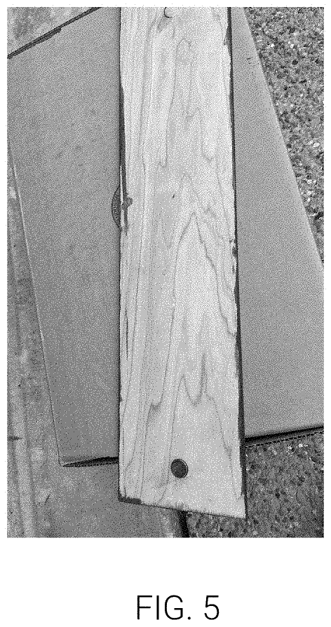

FIGS. 4-5 depict an exemplary embodiment of the invention using wood.

In embodiments, the wood was cut into strips and used to cover any magnetic areas that were preventing a magnetic screen from functioning properly.

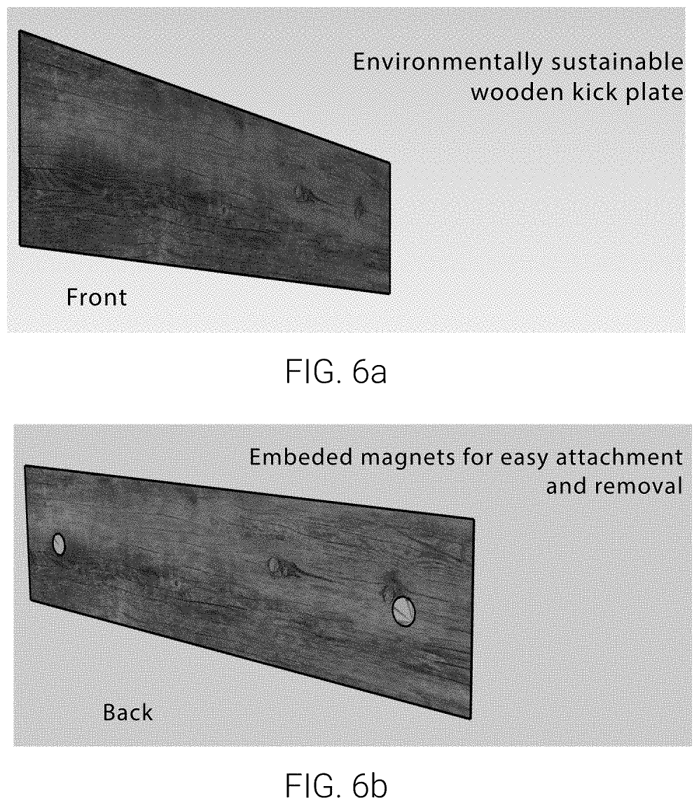

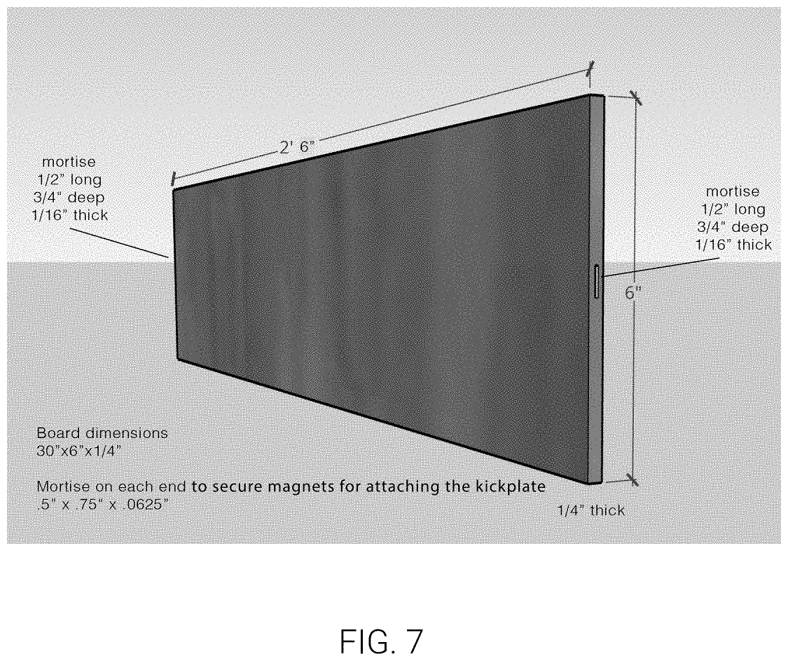

FIGS. 6a-6b depict an alternate view of the front and back surfaces of a device according to the present invention. FIG. 7 depicts a further embodiment, with reference numbers for illustrative purposes only.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A device for improving the functionality of a magnetic screen door installed adjacent a ferromagnetic element comprising:
a panel comprising a rear surface that exhibits ferromagnetic properties and a front surface that does not exhibit ferromagnetic properties;
wherein the panel is configured to removably mate with the surface of a door surface via ferromagnetic attraction;

2. The device of claim 1 wherein the front surface is formed from wood

3. The device of claim 1 wherein the front surface is formed from a polymer

4. The device of claim 1 wherein the front surface is formed from rubber

5. The device of claim 1 wherein the front surface is formed from vinyl

6. The device of claim 1 wherein the rear surface comprises a plurality of magnetic elements that have been joined rear surface using an adhesive.

7. The device of claim 1 wherein the rear surface comprises a plurality of magnetic elements that have been embedded into the rear surface.

8. The device of claim 1 wherein the front surface is configured to cover only an area where the magnetic attraction is not desired.

9. The device of claim 1 wherein the device is shaped and styled to match the underlying door surface.
